(19) United States
(12) Patent Application Publication
(10) Pub. No.: US 2026/0062224 A1
(43) Pub. Date: Mar. 5, 2026

(54) CASSETTE GRADER AND METHOD

(71) Applicant: BAADER Food Systems USA, Inc., Kansas City, KS (US)

(72) Inventors: Douglas Bryan BARNETT, Olathe, KS (US); Ryan John FOLTZ, Bucyrus, KS (US); Ryan Wesley O'DELL, Weatherby Lake, MO (US); Gerald Kent LAUER, Lees Summit, MO (US); Patrick John SCHLOTTER, Harrisonville, MO (US)

(73) Assignee: BAADER Food Systems USA, Inc., Kansas City, KS (US)

(21) Appl. No.: 19/320,184

(22) Filed: Sep. 5, 2025

Related U.S. Application Data
(60) Provisional application No. 63/691,117, filed on Sep. 5, 2024.

(51) Int. Cl. B65G 17/12; B65G 47/96

(52) U.S. Cl. CPC B65G 17/12; B65G 47/962; B65G 2201/0202; B65G 2203/0258; B65G 2207/26

(57) ABSTRACT

A grader system for weighing and distributing food parts to achieve a desired batch weigh includes a conveyor system with a plurality of cups moving along a pathway that encounter a weigh station. The cups are mounted on a tilt frame that is connected to the conveyor system by a support frame assembly and an arm assembly. The support frame assembly is constructed with an open design forming cavities that can be cleaned when the grader system is in use. The arm assembly is at the exterior of the frame assembly and is constructed having a T-shaped cross section permitting cleaning. The tilt frame assembly includes feet that move along rails connected to a load cell at the weighing station.

### CROSS-REFERENCE TO RELATED APPLICATIONS

This application claims the benefit of priority to U.S. Provisional Application No. 63/691,117, filed Sep. 5, 2024, and U.S. Provisional Application No. 63/710,469, filed Oct. 22, 2024, the contents of which are incorporated by reference herein in their entirety.

### BACKGROUND

### 1. Field of the Disclosed Subject Matter

Food processing equipment.

### 2. Background

Food products are often processed based on weight. Accurately determining the weight of food parts and the combination of food parts to achieve a desired batch weight minimizes waste and maximizes yield.

### SUMMARY

A grader system for accurately determining the weight of food parts and the combination of food parts to achieve a desired batch weight includes a conveyor system with a plurality of cups moving along a pathway. A support frame assembly connected to the conveyor system is connected to the cup via a parallel arm assembly and a tilt frame. The arm assembly allows the cups to move upward and downward relative to the support frame assembly, and the tilt frame allows the cup to tilt outward from the grader system at one of several dump stations to deposit the contents of the cups into receptacles to create batches of food parts.

In an implementation, the cups form an upwardly open container with a bottom wall extending from a relatively flat front portion to an inclined rear portion, and an upwardly extending first side wall and opposing second side wall extending rearward and converging at a shallow rear wall. A shallow front wall projecting outward and terminating in a front lip provides a low threshold for the food parts within the cup to clear as they are dumped into a receptacle.

The design of the bottom wall aids in the handling of sticky food parts. The bottom wall is formed from a mid-slope disposed between a front slope and a rear slope, with the front slope being relatively flat, the mid slope being inclined relative to the front slope, and the rear slope having a greater incline than the mid slope. The bottom wall presents an upper surface forming an arrangement of separately spaced button protrusions. The button protrusions decrease the surface area of the cup in contact with the food parts allowing sticky food parts to more easily release from the cup when the contents are being dumped into a receptacle.

### BRIEF DESCRIPTION OF THE DRAWINGS

The present disclosed subject matter is described herein with reference to the following drawing figures, with greater emphasis being placed on clarity rather than scale:

FIG. 1 is an isometric view of a grader according to aspects of the disclosed subject matter.

FIG. 2 is a top plan view of the grader of FIG. 1.

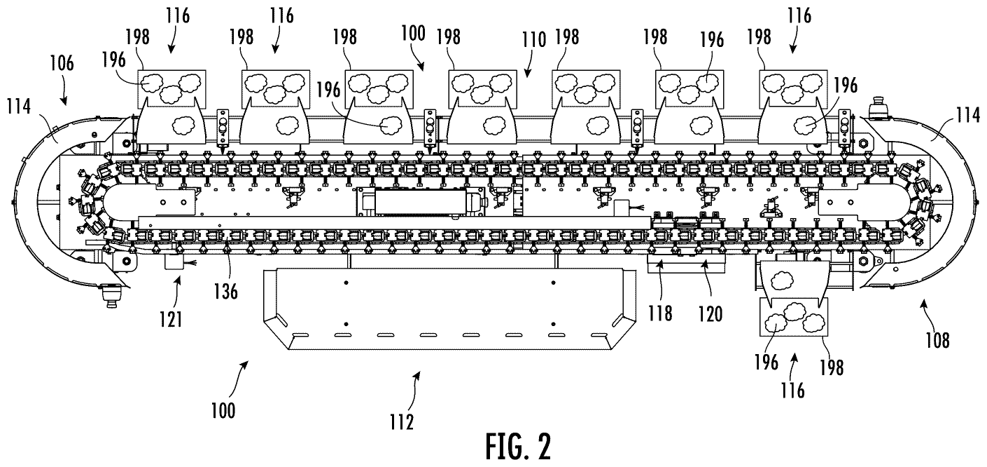

FIG. 3 is a side elevation view of the grader of FIG. 1.

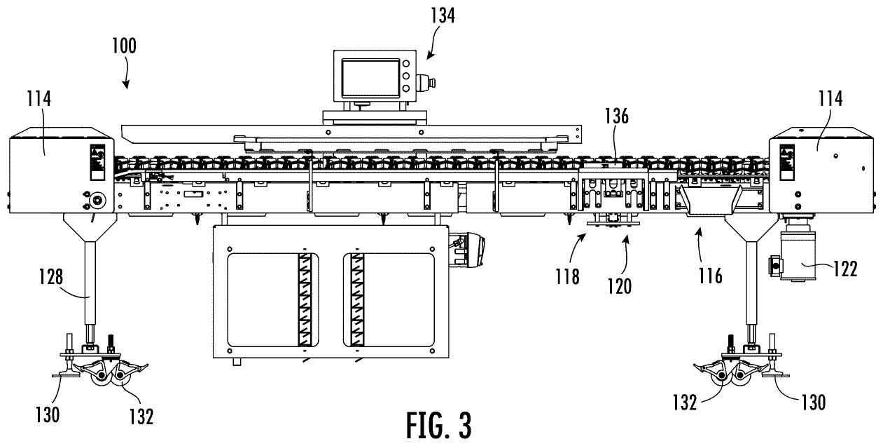

FIG. 4 is an isometric view from above of a cup and support frame assembly according to aspects of the disclosed subject matter.

FIG. 5 is an isometric view from above of an implementation of a cup according to aspects of the disclosed subject matter.

FIG. 6 is a side elevation view of the cup of FIG. 4.

FIG. 7 is a bottom plan view of the cup of FIG. 4.

FIG. 8 is a top plan view of the cup of FIG. 4.

FIG. 9 is an isometric view from above of an implementation of a cup according to aspects of the disclosed subject matter.

FIG. 10 is an isometric view from the side of an implementation of the cup of FIG. 9.

FIG. 11 is a side elevation view of the cup of FIG. 9.

FIG. 12 is a top plan view of the cup of FIG. 9

FIG. 13 is a bottom plan view of the cup of FIG. 10.

FIG. 14 is an isometric view from above of the frame assembly of FIG. 4.

FIG. 15 is an isometric view from above of the frame assembly of FIG. 14.

FIG. 16 is an isometric view from above of the frame assembly of FIG. 15 without the tilt frame.

FIG. 17 is a side elevation view of the frame assembly of FIG. 14.

FIG. 18 is an isometric view from above of an implementation of a cup according to aspects of the disclosed subject matter.

FIG. 19 is an isometric view from the side of an implementation of the cup of FIG. 18.

FIG. 20 is an enlarged fragmentary view taken generally in circle 20 in FIG. 18.

FIG. 21 is a block diagram of an embodiment of a control system operable with the disclosed subject matter.

### DETAILED DESCRIPTION

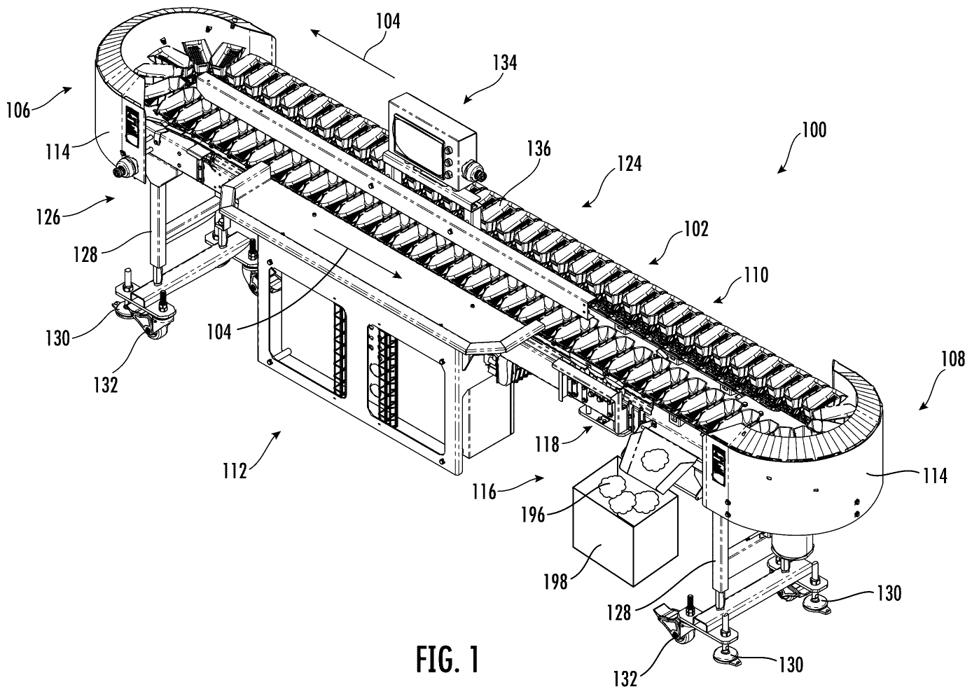

Referring to FIG. 1, an implementation of a grader 100 system includes a conveyor system 102 with a plurality of cassettes moving along a pathway 104 for gathering food parts 196 that are used for creating a desired total weight of food parts 196 within a receptacle 198. Each cassette comprises a cup, such as cups 136, 250, or 300, connected to the conveyor system 102 by a support frame assembly 200, arm assembly 220, and tilt frame 168. The arm assembly 220 is connected to the tilt frame 168 and the support frame assembly 200 allowing the cup to move upward and downward relative to the support frame assembly 200. The tilt frame 168 connects to the arm assembly 220 and cup and allows the cups to rotate relative to the support frame assembly 220, and thereby tilt outward from the grader 100 at one of several dump stations 116 to deposit the contents of the cups into receptacles 198 to create batches of food parts 196.

The grader 100 will be discussed in general in reference to cup 136, but any combination of cups 136, 250, and 300 can be used. The grader 100 extends from a first end 106 to a second end 108 with an opposing first side 110 and a second side 112. The sides 110, 112 include one or more dump stations 116 consisting of a sloped surface to direct the contents of the cup into the receptacle below. Each end 106, 108 includes a spray hood 114 with nozzles for spraying of liquid for washing the cups, tilt frames 168, arm assemblies 220, and support frame assemblies 200 after the contents of the cups have been deposited in receptacles. The hoods 114 contain overspray, and guard the ends of the conveyor system 102 where the space between the cups increases when the frame assemblies 200 transverse the first and second ends 106, 108, and decreases as the frame assemblies 200 translate from the first end 106 to the second side 112, and transverse from the second end 108 to the first side 110. The conveyor system 102 travels along an elongated circular pathway and is moved using a motor 122. The conveyor system 102 is connected to a base 124 with a frame 126 and ground-engaging legs 128 depending therefrom. The ground-engaging features include feet 130 for leveling the grader 100 when it is in an operating position, and wheels 132 for moving the grader 100 system.

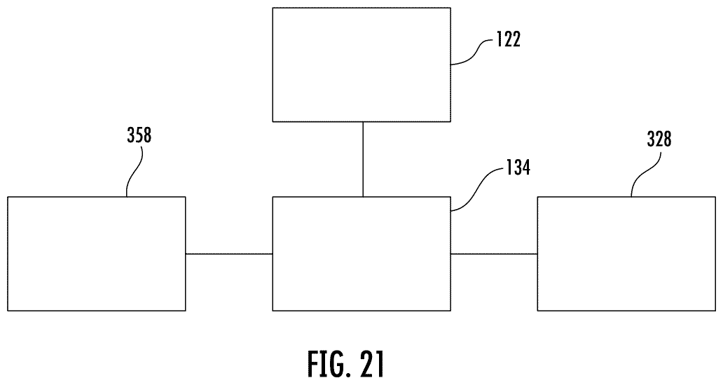

In an implementation, the grader 100 system includes a first weigh station 118 that contact the tilt frames 168 to weigh the cups as they travel along the conveyor system 102. In an implementation, the grader 100 system includes the first weigh station 118 and an adjacent second weigh station 120. Referring to FIG. 1, the grader 100 system is operated using a programmable logic controller (PLC) 134 that controls the motor 122 and processes signals from the load cells 358, 328 associated with weigh stations 118, 120. Referring to FIG. 21, the PLC 134 includes circuitry connected to memory. The circuitry may be dedicated circuitry or a general-purpose processor. The processor executes the grader 100 system operating system, and other functions of the system including processing data signals received from input devices, such as weigh cells and position sensors, and communicating data signals to output devices, such as the motor 122 and an actuator for tilting the tilt frame 168. The memory may include non-volatile memory such as a dynamic storage device, random-access memory, read-only memory, flash memory, a hard drive, or any other suitable optical, magnetic, or solid-state computer readable media, as well as a combination thereof.

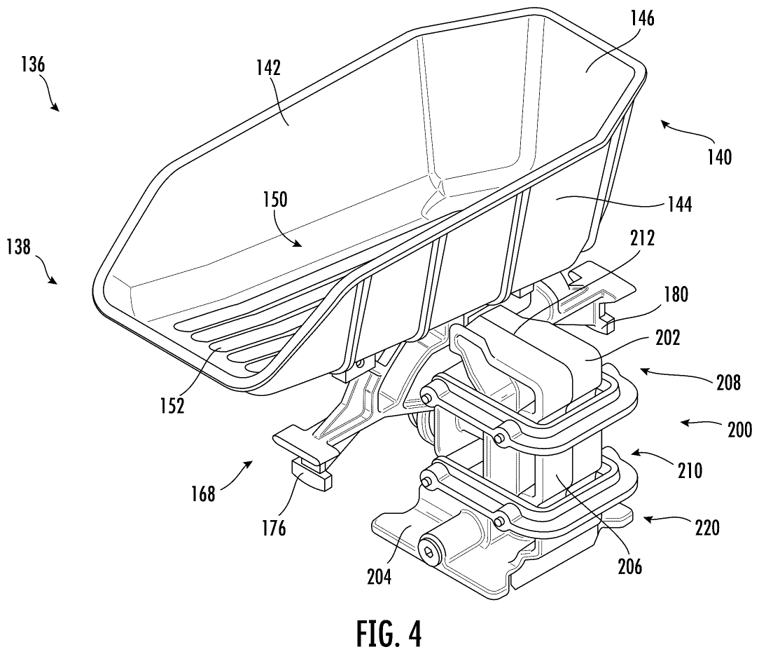

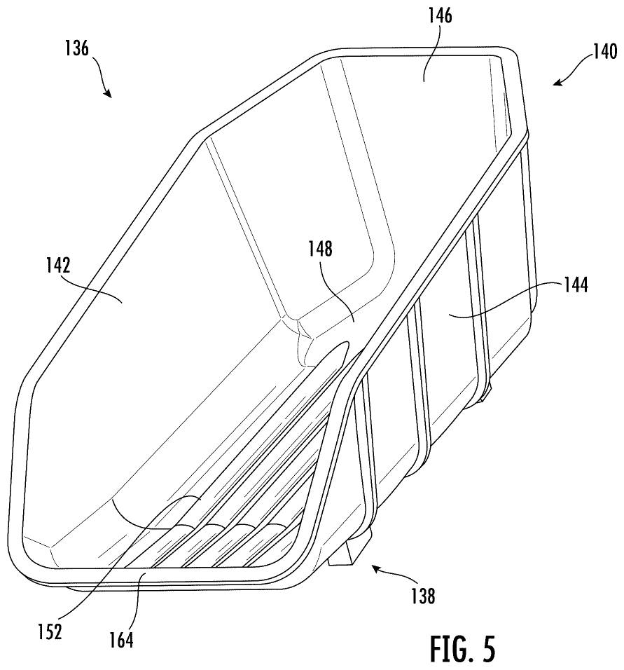

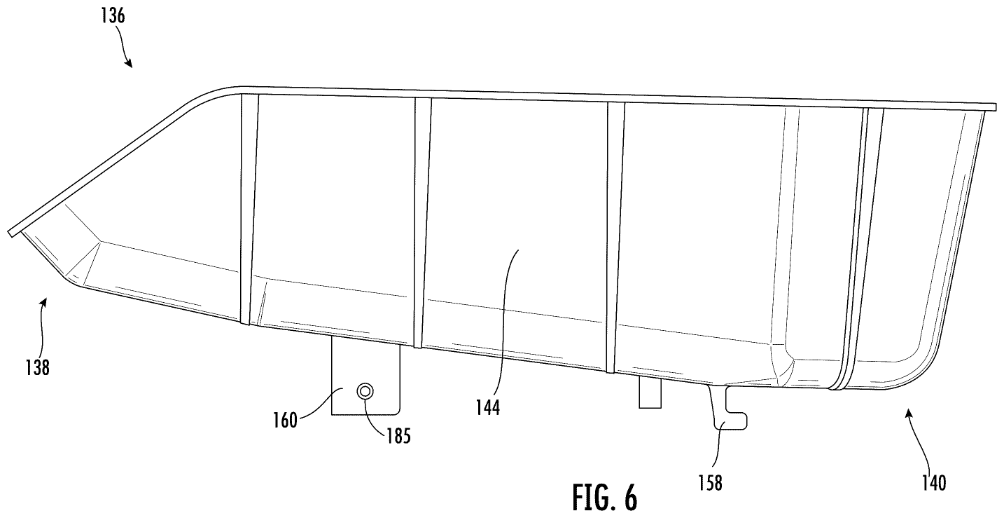

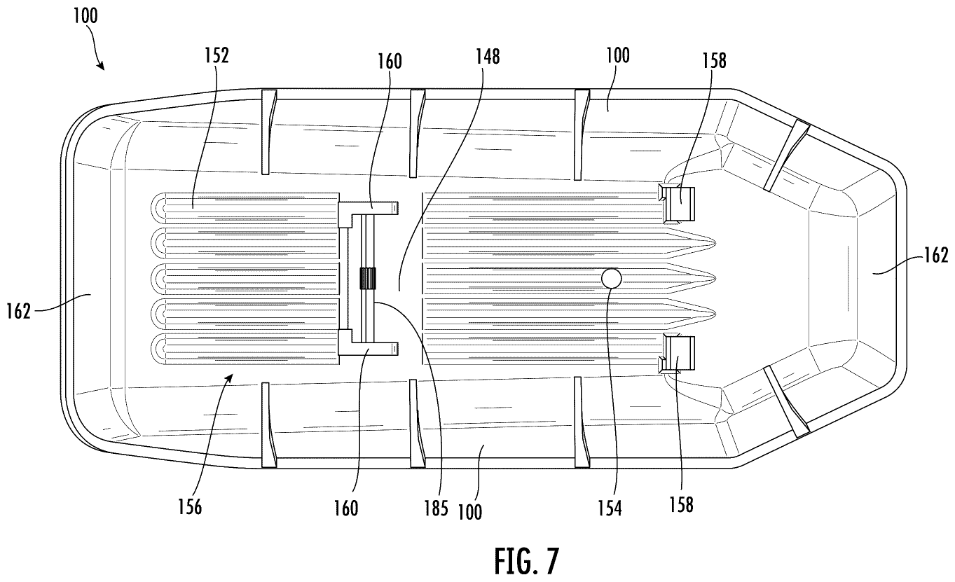

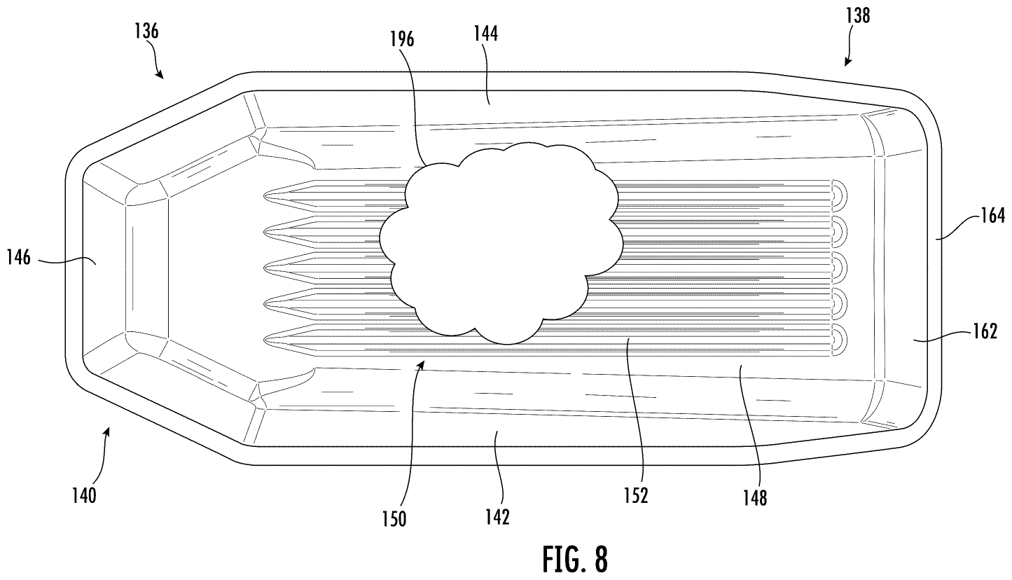

Referring to FIGS. 4-8, in an implementation, the cup 136 forms an elongated upwardly open container extending from a first end or rear portion 140 to a second end or front portion 138. The cup 136 travels in a horizontal position, as shown in FIGS. 4 and 6, as it is moved along the pathway 104 in a first direction. An upwardly extending first side wall 142 and opposing second side wall 144 are joined at the first end by a rear wall 146 and at the second end by a front wall 146. The front wall 162 extends forward and upward from a bottom wall 148 toward the second end forming a front lip 164. The bottom wall 148 forms a bracket 160 at a bottom surface 156 for connecting the cup 136 to the tilt frame 168, and cleat 158 rearward of the bracket 160 for connecting the cup 136 to the tilt frame 168. The bracket 160 includes a metal pin 185 aiding in connecting the cup 136 and pivoting of the cup 136 about the tilt frame 168. Elongated protrusions 152 extend from an upper surface 150 of the bottom wall 148. A drain hole 154 extending through the bottom wall 148 allows liquid to drain from the cup 136. In an implementation, the cup 136 is made of high-density polyethylene (HDPE) or ultra-high molecular weight polyethylene (UHMW), and manufactured by conventional means, such as molding, or additive or reductive manufacturing.

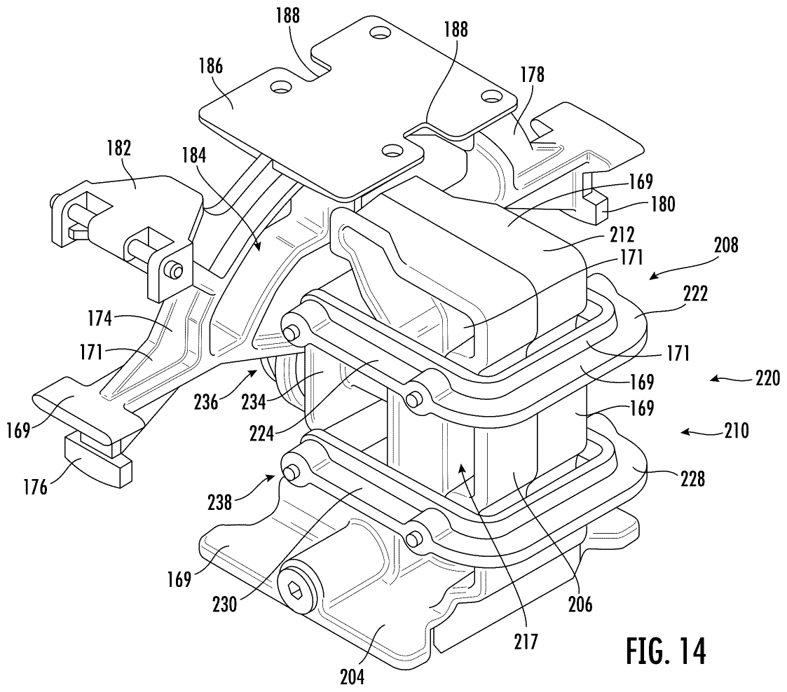

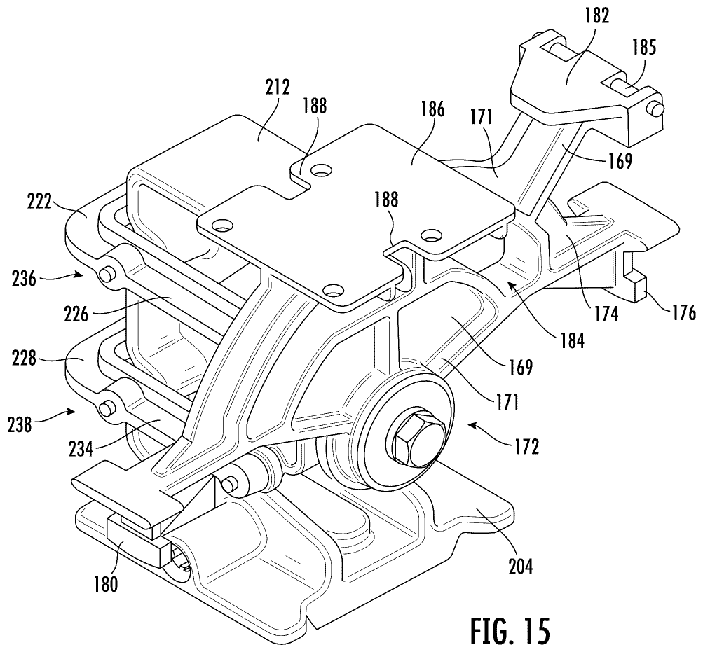

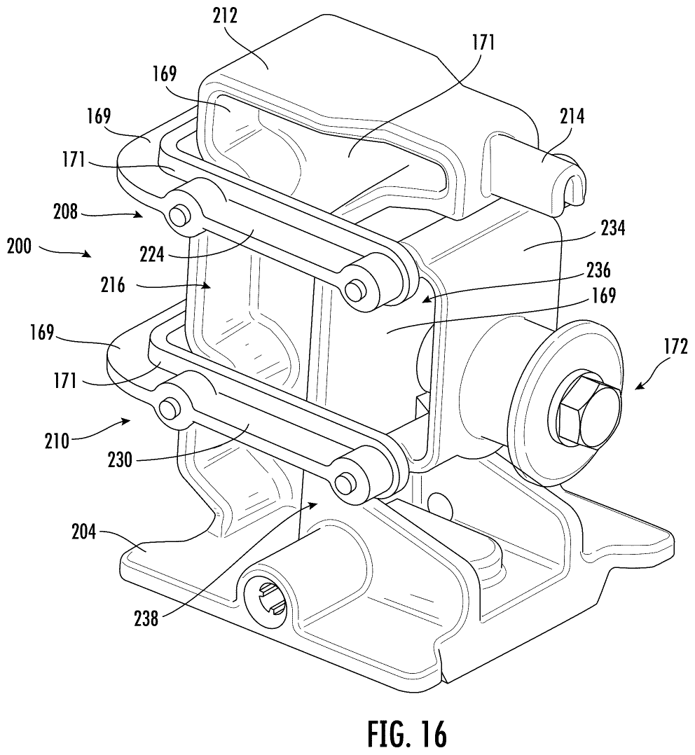

The tilt frame 168 permits the contents of the cup 136 to be weighed by the weigh stations 118, 120, and dumped at dump stations 116. The tilt frame 168 has a generally arch-shaped frame 170 that is pivotally connected to the arm assembly 220 by a hub 172. The frame 170 forms a front leg 174 extending from a rear platform 186 at the top of the frame 170, with the front leg 174 forming a downwardly extending front foot 176. The frame 170 forms a front platform 182 generally above the front foot 176, providing an attachment point for the bracket 160, with the rear platform 186 forming recesses 188 for receiving the cleats 158. A rear leg 178 extends from the rear platform 186 forming a downwardly extending rear foot 180. The hub 172 permits movement of the tilt frame 168 vertically, such as when the contents of the cup are weighed at a weigh station 118, 120, and between a level position (FIGS. 14-16) and a tilted position whereby the rear foot 180 is elevated above the front foot 176, such as when the contents of the cup 136 are dumped at a dump station 116. The hub 172 is pivotally connected to the arm assembly 220 by a pivot frame mount 234. In an implementation, the tilt frame 168 is made of HDPE or UHMW, and manufactured by conventional means, such as molding, or additive or reductive manufacturing.

The pivot frame mount 234 is connected to the support frame assembly 200 by the arm assembly 220. The arm assembly 220 includes a U-shaped upper arm 222 and a U-shaped lower arm 228 at the exterior of support frame assembly 200, forming a frame that moves in parallel to control vertical movement of the tilt frame 168. The upper arm 222 includes a front lateral 224 and rear lateral 226 joined by a side lateral, with the front and rear laterals pivotally connected at a first end to an upper pivot 236 at an upper portion of the pivot frame mount 234. The lower arm 228 includes a front lateral 230 and rear lateral 232 joined by a side lateral, with front and rear laterals pivotally connected at a first end to a lower pivot 238 at a lower portion of the pivot frame mount 234. A second end of the upper arm 222 and lower arm 228 are pivotally connected to the body 206 of the support frame assembly 200 at an upper pivot 208 and lower pivot 210, respectively. In an implementation, the arm assembly 220 is made of HDPE or UHMW, and manufactured by conventional means, such as molding, or additive or reductive manufacturing.

The support frame assembly 200 has a support 202 forming body 206 extending between a base 204 and a head 212. In an implementation, the support frame assembly 200 is made of HDPE or UHMW, and manufactured by conventional means, such as molding, or additive or reductive manufacturing. The base 204 is connected to the conveyor system 102. The head 212 forms a pin-like structure 214 that extends into an arch-shaped rear opening 184 formed by the rear leg 178. An arch-shaped front opening 183 is formed by the front leg 174. The rear opening 184 extends between a first stop 192 adjacent a detent 190 below the rear platform 186, and a second stop 194 adjacent the rear foot 180. The pin 214 engages the detent 190 within the rear opening 184 to prevent rotation of the frame 170 about the hub 172 when the cup 136 is moved along the conveyor system 102. Vertical movement of the tilt frame 168 disengages the pin 214 from the detent 190 allowing the tilt frame 168 to rotate about the hub 172 whereby the front platform 182 moves downward, and the rear platform 186 moves upward, causing the contents of the cup 136 to be expelled from the cup 136. Downward movement of the front platform 182 is arrested by the pin 214 contacting the second stop 194.

The processing of food parts 196, such as poultry parts, can cause tissues and debris to accumulate within the components of the tilt frame 168, arm assembly 220, and support frame assembly 200, making it important to clean the cassette during operation of the grader 100 system. Accordingly, these features are manufactured with a fairly open design using a lateral flange support structure 169 and a vertical web support structure 171 to make the components easier to clean. For example, the tilt frame 168 includes the flange and web support structures 169, 171, and front and rear openings 183, 184. The upper arm 222 and lower arm 228 are at the exterior of the support frame assembly 200 instead of housed within, and are formed from lateral flange support structure 169 and vertical web support structure 171 resulting in the front laterals and rear laterals forming a T-shaped cross section, such as, for example, as would be shown by a cross section taken of the first lateral 224 between upper pivot 236 and upper pivot 208. Locating the arms 222, 228 at the exterior of the support frame assembly 200, instead of housing the arms within, increase the ease of cleaning the structures. Attaching the upper and lower arms 222, 228 at the exterior of the support frame assembly 200 allows the interior of the support frame assembly to be manufactured whereby it has an open design. The support frame assembly 200 has a centrally located vertical web support structure 171, with an outer edge circumscribing the vertical web support structure 171 formed by the lateral flange support structure 169 resulting in open spaces such as a first cavity 216 at a rear end of the body 2016 and a second cavity 217 at a front end of the body 206 allowing these features to be cleaned with liquids. As a result, as the cassette moves along the pathway 104, the arms 222, 228, first cavity 216, and second cavity 217 are open and their surfaces are accessible for cleaning by liquids, such as sprays of liquid from the spray hoods 114.

Returning to operation of the cup 136, when the cup 136 is selectively tilted outward from the grader 100 system at a dump station 116, the bottom wall 148 moves from an orientation whereby it declines as it extends from the front portion 138 to the rear portion 140 to an orientation whereby the bottom wall 138 declines as it extends from the rear portion 140 to the front portion 138, allowing the contents of the cup 136 to be deposited in the receptacles 198 below the dump station 116.

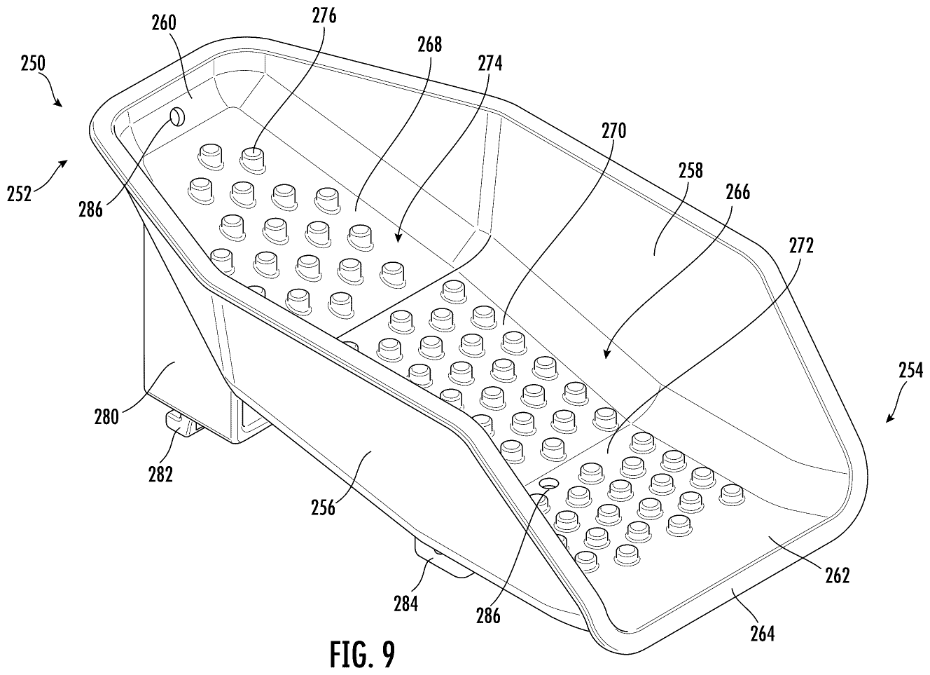

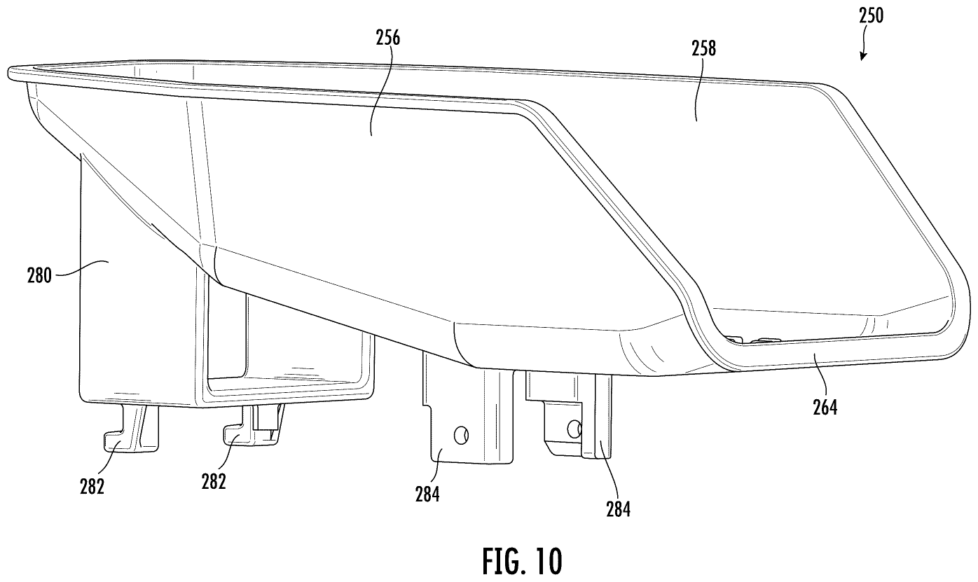

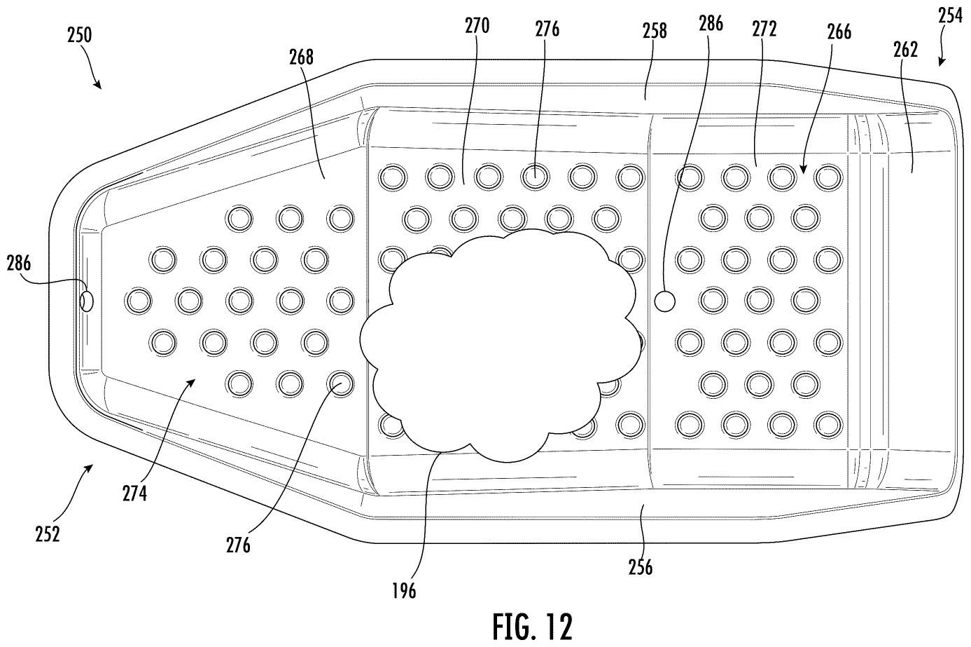

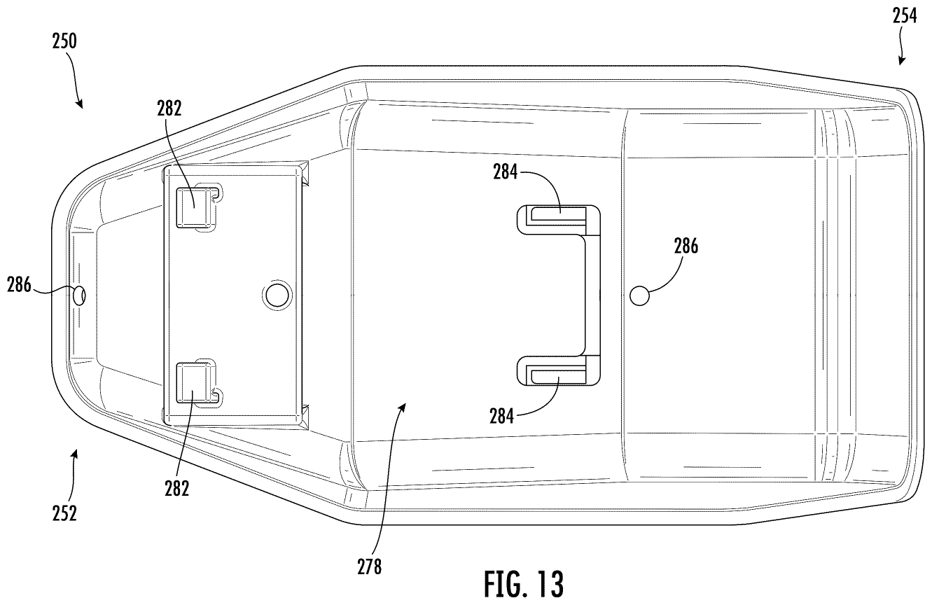

Referring to FIGS. 9-13, an alternative implementation of the cup is shown, whereby a cup 250 with a rearwardly inclining bottom wall 266 with an upper surface 274 forming an arrangement of a plurality of separately spaced button protrusions 276 provides an ease of dumping of contents. The cup 250 can be used with the tilt frame 168 by connecting arms of a bracket 284 to the front platform 182 by the pin 185 and cleats 282 to the rear platform 186 in the same manner as with cup 136. The protrusions 276 decrease adhesion between sticky food parts 196 and the cup 250 by minimizing the cup 136 surface 274 in contact with the food parts 196.

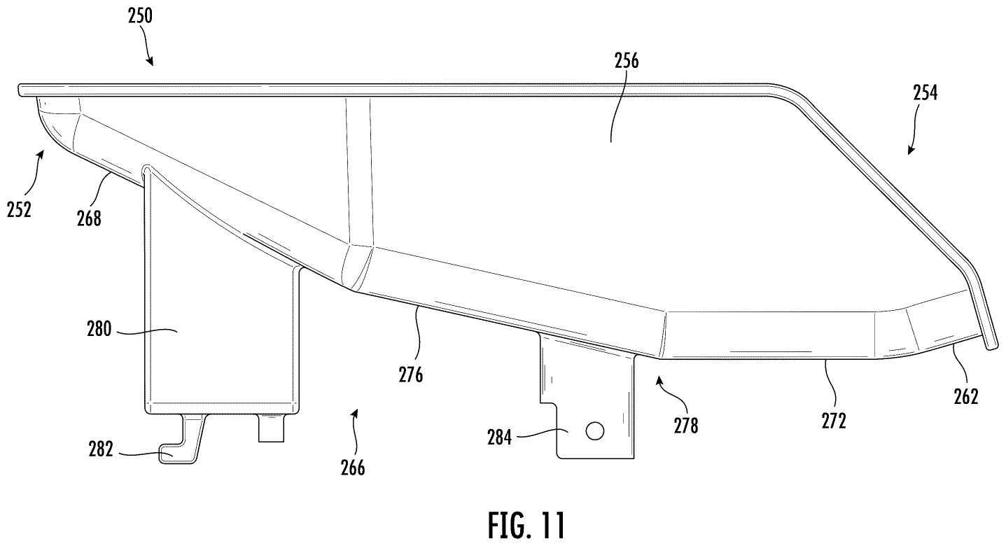

The cup 250 forms an upwardly open container extending from a relatively flat front portion 254 to an inclined rear portion 252. An upwardly extending first side wall 256 and opposing second side wall 258 extend rearward converging at a shallow rear wall 260. A shallow front wall 262 projects outward terminating in a front lip 264. The bottom wall 266 is formed from a mid-slope 270 disposed between a front slope 272 and a rear slope 268. The front slope 272 is relatively flat, with the mid slope 270 being inclined relative to the front slope 272, and the rear slope 268 having a greater incline than the mid slope 270 shown in FIGS. 9 and 11. The bottom wall 266 forms the bracket 284 extending from a bottom surface 278 of the cup 250, and a mount 280 rearward of the bracket 284 forming the cleats 282. A drain hole 286 extending through the bottom wall 266, and a drain hole 286 extending through the rear wall 260 allow liquids to drain from the cup 250.

The inclining bottom wall 266 design of the cup 250 positions the food parts 196 deposited at a rear portion 252 of the cup 250 at an elevated position relative to a front portion 254 of the cup 250, with the protrusions 276 further aiding in release of the food parts 196 from the cup 250. When the cup 250 is selectively tilted outward from the grader 100 system at a dump station 116, the rear slope 268 moves from an orientation whereby it inclines as it extends from the front portion 254 to the rear portion 252 to an orientation whereby the rear slope 268 is steeply inclined relative to the front slope 272, ejecting the food part 196 horizontally from the rear slope 268. This quick rotation of the cup 250 and sudden stop when the tilt frame 168 contacts the second stop 194 causes the food part 196 to roll downward toward food parts 196 resting on the mid slope 270 and front slope 272. At the same time, the food parts 196 at the mid slope 270 and front slope 272 move downward from the slopes, with the resulting collective inertia of the food parts causing the parts to roll out of the cup 250 and into a receptacle 198 at a dump station 116.

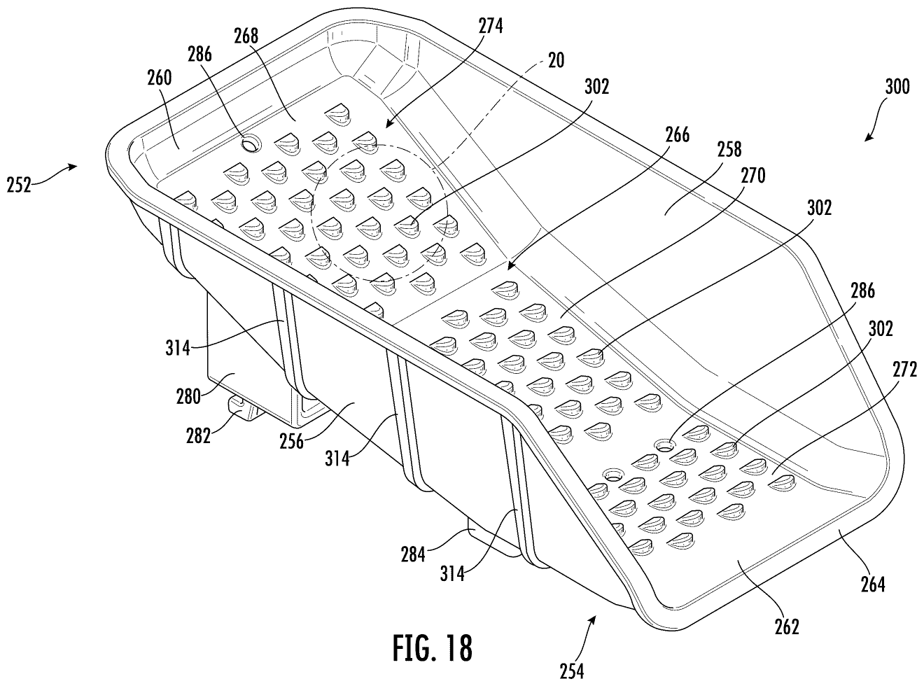

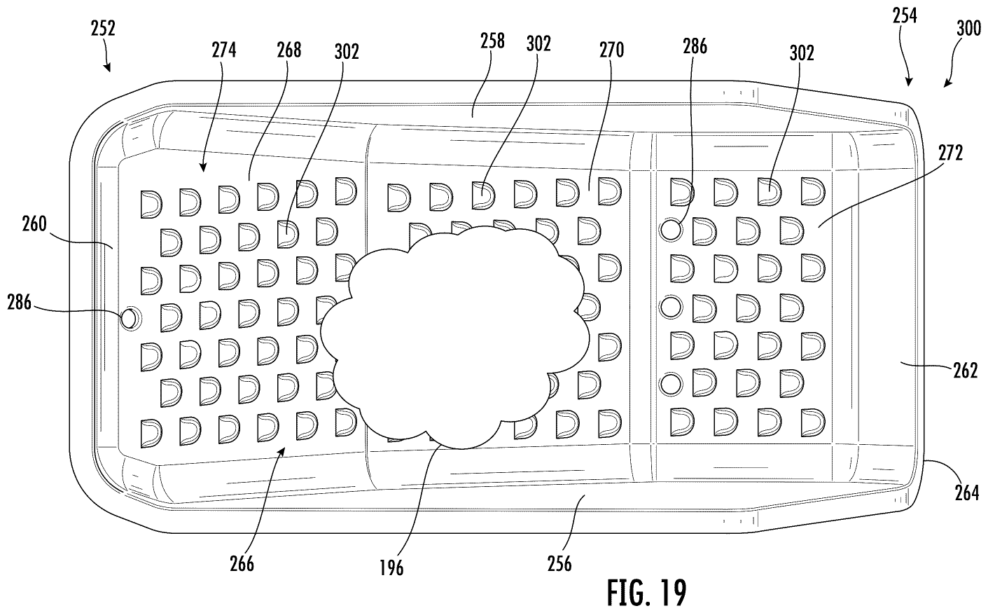

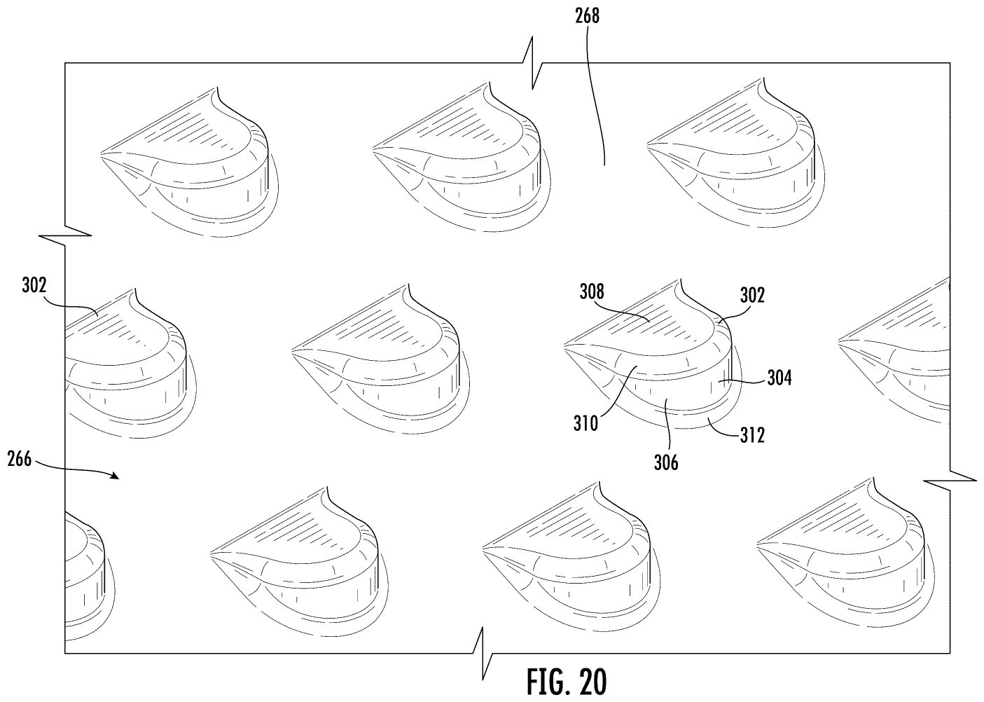

Referring to FIGS. 18-20, an alternative implementation of the cup is shown, whereby a cup 300 has an upper surface 274 forming an arrangement of a plurality of separately spaced protrusions 302 extending from the bottom wall 266. The protrusions 302 are formed by an upper portion of the upper surface 274 that extends toward the front portion 254 to form an upper surface 308 that terminates at a convex front wall 304. First and second lateral walls 306 on either side of the front wall 304 extend toward the rear portion 252. The front wall 304 and lateral walls 306 transition downward to the bottom wall 266 by a lower edge 312 forming a concave fillet shape, transition upward to the upper surface 308 at an upper edge 310 forming a curved edge or half bull nose, and extend from a narrow portion at the intersection of the upper surface 308 and bottom wall 266 at the rear to a wide portion at the front wall 304. The first side wall 256 and second side wall 258 include several reinforcing ribs 314 to add structural support to the walls. The smooth transition between the upper surface 274 and the upper surface 308 of the protrusions 302 eliminates an area at the rear portion 252 of the protrusion 302 that could trap debris or residue from the food part 196, keeping the cup 300 and associated grader system 100 clean and more sanitary.

The grader 100 system allows for the various cups along the conveyor system 102 to be populated at the first end 106 with one or more food parts 196 that are then advanced to the weigh stations. The weight of the cup contents determine whether the grader 100 system holds the contents of the cup and does not initiate a dump at a dump station 116, or the grader 100 system dumps a batch of food parts 196 from a specific cup at a dump station 116.

In use, the grader 100 system is used to fill receptacles 198 to an accumulated food part 196 weight value. A desired total weight of food parts 196 in a receptacle 198 may be specified for a receptacle 198. To achieve an accurate total weight for a receptacle 198, food parts 196 are added to empty cups, the grader 100 system weighs the contents of each cup passing through a weigh station and selectively dumps the content of each cup at particular dump station 116.

The cassettes move along the pathway 104, where with each cassette, the cup and tilt frame 168 lead the support frame assembly 200 along the pathway 104. After cups are cleaned at the first end 106, the empty cups pass across an optional tare weigh station 121 where the tare weight of the empty cup, tilt frame 168, and pivot frame mount 234 are determined. The tare weigh station 121 includes the same contacts and load cell and has the same operation and function as weigh station 118 described below, and a first tare weigh station can be adapted to weigh cassettes that encounter weigh station 118, and a second tare weight station can be adapted to weigh cassettes that encounter weigh station 120.

In an arrangement where cup 300 is used having a smooth transition between the upper surface 274 and the upper surface 308 of the protrusions 302, the tare weight of the empty cup may be taken at an irregular interval due to the likelihood of little or no debris that accumulates within the cup 300.

Cups advance through the loading zone 105 where food parts 196 are deposited in empty cups. The cups with food parts 196 move from the first end 106 across one or more weigh stations to the second end 108.

As the cups enter and exit the weigh station 118, the tilt frames 168 encounter guides operably connected to a load cell, whereby the guides elevate the cup and stabilize the cups as the weight of the food parts 196 within the cup is determined. The load cell measures the weight of the tilt frame 168 and arm assembly 220, and the corresponding cup and food parts 196 in the cup. A first weigh station 118 includes a front contact 352 positioned to encounter the front foot 176 and a rear contact 354 to encounter the rear foot 180. The contacts are operably connected 356 to a load cell 358, such as by a physical connection, for detecting a weight value of the cup and its contents, tilt frame 168, arm assembly 220, and pivot frame mount 234. In an implementation, the front and rear contacts 352, 354 are elongated parallel rails extending in a direction from the first end 106 to the second end 108, each forming a contact segment having a middle portion disposed between an inclined portion at a first end and a declined portion at a second end. As the cassette moves from the first end 106 to the second end 108, first the front foot 176 engages the first end of the front contact 352 and the rear foot 180 contacts the first end of the rear contact 354. As the conveyor system 102 advances the cassette toward the second end 108, the feet move from the first end of the contact segments to the middle portion of the contact segments, resulting in the cup and its contents, tilt frame 168, arm assembly 220, and pivot frame mount 123 moving upward putting a load on the load cell 358. As the tilt frame 168 moves along the middle portion, the displacement of the contacts 352, 354 are registered by the load cell 358, and a signal determinative of the weight of the cup and its contents, tilt frame 168, arm assembly 220, and pivot frame mount 123 is sent to the PLC 134 and the gross weight value associated with the signal is calculated and assigned to the cassette. The grader 100 system has a known weight value for the cup, tilt frame 168, arm assembly 220, and pivot frame mount 123. The grader 100 system calculates the net weight of the content of the cup, such as the food parts 196 therein, by removing the known weight value for cup, tilt frame 168, arm assembly 220, and pivot frame mount 123 from the gross weight value. The grader 100 system measures the resulting net weight of food parts 196 to a high degree of accuracy. The net weight value of the food parts 196 is assigned to the cassette. The greater the length of the contact segment, the longer load cell 358 detects a signal, permitting the PLC 134 to more accurately determine the weight value associated with the signal. As the tilt frame 168 moves from the middle portion to the declined portion, the cup and its contents, tilt frame 168, arm assembly 220, and pivot frame mount 123 move downward and the feet 176, 180 are removed from contact with the contacts 352, 354. Thereafter, the weighed cups move toward the second end 108 and toward the dump stations 116.

In an implementation, the grader 100 includes two adjacent weigh stations 118, 120 allowing two adjacent cups to be weighed at the same time. In such an implementation, the weigh stations 118, 120 are offset, whereby the front and rear contacts of the first weigh station 118 are offset from the front and rear contacts of the second weigh station 120, providing an inside weigh track and an outside weigh track, respectively. Further, the tilt frames 168 on the conveyor system alternate whereby a tilt frame has front and rear feet 176, 180 that align with the load cell contacts of the first weigh station 118, and the adjacent tilt frame has front and rear feet that align with the load cell contacts of the second weigh station 120. This implementation allows two cups to be weighed simultaneously, and allow for the length of the contacts to be increased, allowing the grader 100 to run faster.

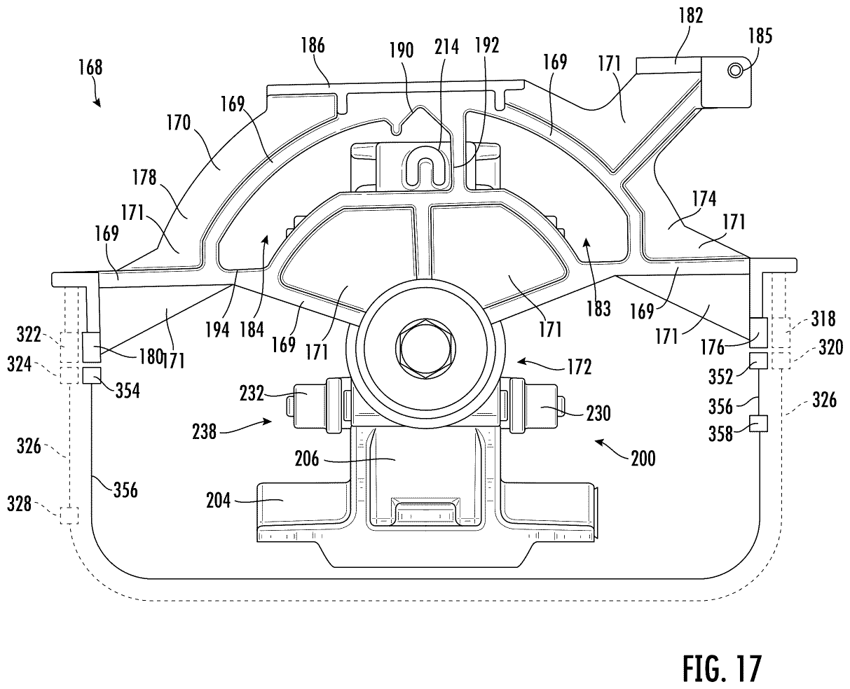

In an implementation of adjacent weigh stations 118, 120, the conveyor system 102 would include cassettes with alternating first and second tilt assemblies. Referring to FIG. 17, the first tilt assembly would have the tilt frame 168 as described above forming the corresponding front foot 176 and rear foot 180 at first locations and encounter weigh station 118. The second tilt assembly would have a tilt frame 168 with a front foot 318 at a second location, such as positioned outboard from the front foot 176 first location, and a rear foot 322 at a second location, such as positioned outboard from the rear foot 180 first location and encounter weigh station 120. Weigh station 120 includes the same contacts and load cell features and has the same operation and function as weigh station 118 but the front and rear contacts are positioned to engage the feet 318, 322. Weigh station 120 utilizes a front contact 320, adjacent to front contact 352, to engage the front foot 318, and a rear contact 324, adjacent to rear contact 354, to engage the rear foot 322. Contacts 320, 324 are operably connected 326 to a load cell 328, such as by a physical connection, for detecting a weight value of the cup and its contents, etc. associated with the second tilt assembly.

At any time, the grader 100 system has weighed any number of cups and has logged net weight values for the food parts 196 therein. As a result, the grader 100 system has any number of highly accurate, small population batches of food parts 196 to select from to transfer or dump into a receptacle 198 to achieve the desired total weight of food parts 196 within the receptacle 198.

In an implementation, the grader 100 system includes a second conveyor system 102 with weigh stations, dump stations, and cups, etc., as described above, to add additional capacity and populations of food parts 196 to transfer into the receptacles 198. Such an arrangement of a second conveyor system 102 can be located adjacent the first conveyor system 102, such as above or below a first conveyor system 102.

The receptacles 198 allow the grader 100 system to gather food parts 196 for deposition as a batch on a takeaway conveyor for packaging or further processing of the food parts 196.

Having described the disclosed subject matter, what is claimed as new and desired to be secured by Letters Patent is:

1. A grader apparatus, comprising:
a first conveyor system;
a plurality of cassettes connected to the first conveyor system, each cassette comprising:
a first cup extending from a front portion to a rear portion;
a support frame assembly connected to the first conveyor system;
a tilt frame, wherein the first cup is mounted to the tilt frame;
a pivot frame mount connected to the tilt frame; and
an arm assembly connected to the pivot frame and the support
frame assembly, wherein the arm assembly comprises:
a front lateral and a rear lateral, wherein the front lateral and rear lateral are formed from a lateral flange support structure and a vertical web support structure, and wherein the front lateral and rear lateral form a T-shaped cross section.

2. The grader apparatus of claim 1, comprising:
wherein the first cup further comprises:
an upwardly extending first side wall and opposing upwardly extending second side wall, wherein each side wall extends rearward converging at a rear wall at the rear portion, and wherein each side wall extends forward converging at a front wall at the front portion;
wherein the front wall extends forward and upward and terminates at a front lip; and
a bottom wall formed from a mid-slope disposed between a front slope at the front portion and a rear slope at the rear portion, wherein the mid slope is inclined relative to the front slope, and the rear slope is inclined relative to the mid slope.

3. The grader apparatus of claim 2, comprising:
wherein the bottom wall forms a protrusion.

4. The grader apparatus of claim 3, comprising:
wherein the protrusion comprises:
an upper surface extending forward from the bottom wall;
a front wall extending from the bottom wall to the upper surface; and
a lateral wall extending upward from the bottom wall to the upper surface, and extending from a narrow portion at an intersection of the upper surface and the bottom wall to a wide portion at the front wall.

5. The grader apparatus of claim 4, comprising:
wherein the protrusion further comprises:
a concave fillet shaped lower edge formed by the intersection of the lateral wall and the bottom wall;
a curved upper edge formed by the intersection of the upper surface and the lateral wall; and
wherein the front wall is convex.

6. The grader apparatus of claim 1, comprising:
wherein the support frame assembly further comprises:
a body extending between a base and a head;
a centrally located vertical web support structure extending between the base and the head;
an outer edge circumscribing the vertical web support structure formed by a lateral flange support structure; and
wherein the vertical web support structure and lateral flange support structure form a first cavity at a rear end of the body, and a second cavity at a front end of the body.

7. The grader apparatus of claim 1, further comprising:
a first weigh station.

8. The grader apparatus of claim 7, further comprising:
a second conveyor system disposed adjacent the first conveyor system, comprising:
a plurality of cassettes connected to the second conveyor system; and
a second weigh station.

9. The grader apparatus of claim 1, comprising:
wherein the tilt frame moves upward and downward relative to the pivot frame mount; and
wherein the tilt frame rotates relative to the pivot frame mount.

10. A grader apparatus, comprising:
a first conveyor system;
a plurality of cassettes connected to the first conveyor system, each cassette comprising:
a support frame assembly connected to the first conveyor system,
wherein the support frame assembly comprises:
a body extending between a base and a head;
a centrally located vertical web support structure extending between the base and the head;
an outer edge circumscribing the vertical web support structure formed by a lateral flange support structure; and
wherein the vertical web support structure and lateral flange support structure form a first cavity at a rear end of the body, and a second cavity at a front end of the body; and
a first cup extending from a front portion to a rear portion, wherein the cup is operably connected to the support frame assembly.

11. The grader apparatus of claim 10, comprising:
wherein the cassette further comprises:
an arm assembly at the exterior of the support frame assembly, comprising:
an upper arm forming a front lateral and a rear lateral; and
a lower arm below the upper arm, the lower arm forming a front lateral and a rear lateral.

12. The grader apparatus of claim 11, comprising:
wherein the upper arm is formed from a lateral flange support structure and a vertical web support structure.

13. The grader apparatus of claim 10, comprising:
wherein the first cup further comprises:
an upwardly extending first side wall and opposing upwardly extending second side wall, wherein each side wall extends rearward converging at a rear wall at the rear portion, and wherein each side wall extends forward converging at a front wall at the front portion; and
a bottom wall formed from a mid-slope disposed between a front slope at the front portion and a rear slope at the rear portion, wherein the mid slope is inclined relative to the front slope, and the rear slope is inclined relative to the mid slope.

14. The grader apparatus of claim 13, comprising:
wherein the first cup further comprises:
a plurality of protrusions formed by the bottom wall, wherein the protrusion comprises:
an upper surface extending forward from the bottom wall;
a front wall extending from the bottom wall to the upper surface; and
a lateral wall extending upward from the bottom wall to the upper surface, and extending from a narrow portion at an intersection of the upper surface and the bottom wall to a wide portion at the front wall.

15. The grader apparatus of claim 10, comprising:
a second conveyor system disposed adjacent the first conveyor system, comprising:
a plurality of cassettes connected to the second conveyor system.

16. The apparatus of claim 15, comprising:
wherein the first conveyor system further comprises:
a first weigh station; and
wherein the second conveyor system further comprises:
a plurality of cassettes connected to the second conveyor system; and
a second weigh station.

17. A grader apparatus, comprising:
a first conveyor system;
a plurality of cassettes connected to the first conveyor system, comprising:
a first cassette, comprising:
a first cup extending from a front portion to a rear portion;
a support frame assembly connected to the first conveyor system;
a first tilt frame assembly forming a front foot and a rear foot; and
wherein the first cup is mounted to the first tilt frame assembly; and
a second cassette, comprising:
a second cup extending from a front portion to a rear portion;
a support frame assembly connected to the first conveyor system;
a second tilt frame assembly forming a front foot and a rear foot; and
wherein the second cup is mounted to the second tilt frame assembly;
a first weigh station, comprising;
a front contact formed by an elongated rail, wherein the front contact is adapted to engage the first tilt frame front foot;
a rear contact formed by an elongated rail, wherein the rear contact is adapted to engage the first tilt frame rear foot; and
wherein the front contact and rear contact are operably connected to a first load cell;
a second weigh station, comprising:
a front contact formed by an elongated rail, wherein the front contact is adapted to engage the second tilt frame front foot;
a rear contact formed by an elongated rail, wherein the rear contact is adapted to engage the second tilt frame rear foot; and
wherein the front contact and rear contact are operably connected to a second load cell; and
wherein the first weigh station front contact is disposed adjacent the second weigh station front contact, and wherein the first weigh station rear contact is disposed adjacent the second weigh station rear contact.

18. The grader apparatus of claim 17, comprising:
wherein the first tilt frame assembly further comprises:
a first arm assembly connected to the first tilt frame assembly, wherein the first arm assembly comprises:
a front lateral and a rear lateral, wherein the front lateral and rear lateral are formed from a lateral flange support structure and a vertical web support structure, and wherein the front lateral and rear lateral form a T-shaped cross section.

19. The grader apparatus of claim 17, comprising:
wherein the first cassette further comprises:
a support frame assembly connected to the first conveyor system and the first tilt frame;
wherein the support frame assembly further comprises:
a body extending between a base and a head;
a centrally located vertical web support structure extending between the base and the head;
an outer edge circumscribing the vertical web support structure formed by a lateral flange support structure; and
wherein the vertical web support structure and lateral flange support structure form a first cavity at a rear end of the body, and a second cavity at a front end of the body.
